(19) United States
(12) Patent Application Publication
(10) Pub. No.: US 2025/0367902 A1
(43) Pub. Date: Dec. 4, 2025

(54) GRIP DEVICE

(71) Applicants: Steven Casamento, Gilbert, AZ (US); Michael L Caster, II, Gilbert, AZ (US)

(72) Inventors: Steven Casamento, Gilbert, AZ (US); Michael L Caster, II, Gilbert, AZ (US)

(21) Appl. No.: 18/779,537

(22) Filed: Jul. 22, 2024

Related U.S. Application Data
(60) Provisional application No. 63/653,570, filed on May 30, 2024.

(51) Int. Cl. B32B 3/30; A63C 17/01; B32B 27/08; B32B 27/32; B32B 27/40

(52) U.S. Cl. CPC B32B 3/30; B32B 27/08; B32B 27/32; B32B 27/40; A63C 17/01; B32B 2274/00; B32B 2307/56; B32B 2307/7376; B32B 2307/744; B32B 2405/00; B32B 2605/00

(57) ABSTRACT

The invention pertains to a grip device designed to couple to a board's surface for an individual's feet or hands. The device comprises a base layer, an adhesive layer, and a traction layer. The base layer is configured to attach to the board's surface, while the adhesive layer secures the device to the board. The traction layer, disposed on the base layer, features a plurality of raised pointed protrusions of varying sizes and heights, providing enhanced grip. The grip device can be of various shapes, including rectangular with radius corners or polygonal. The device is made of a thermoplastic material such as TPU that conforms to the contour of the board's surface. The adhesive layer can be an acrylic adhesive, rubber-based adhesive, or silicone adhesive.

### CROSS REFERENCE TO RELATED APPLICATIONS

The present application claims the benefit under 35 U.S.C. 119 of U.S. Provisional Patent Application Ser. No. 63/653,570 filed May 30, 2024. The U.S. Provisional Patent Application Ser. No. 63/653,570 is hereby incorporated by reference in its entirety.

### FIELD OF THE INVENTION

The present invention relates to grip devices for boards or personal electric vehicles, and more particularly, a grip device that provides enhanced traction and stability for the user's feet on the surface of the board, vehicle or any other surface requiring a gripping surface.

### BACKGROUND OF THE INVENTION

The field of the present context encompasses gripping surfaces for personal electric vehicles, specifically focusing on decks that provide stability, comfort, and enhanced control. The proliferation of personal electric vehicles, such as electric unicycles (EUCs) and electric scooters, has necessitated advancements in technologies that ensure rider safety and performance. Conventional materials used in the manufacture of these gripping surfaces primarily include metallic spikes, grip tape, and various types of rubberized surfaces. Although these materials provide varying levels of grip, they exhibit significant shortcomings, particularly in terms of durability, customization, and comfort.

Grip tape, traditionally used on skateboard decks and pedal surfaces of electric unicycles, consists of a sandpaper-like material affixed to the surface of the vehicle deck. Despite its widespread use, grip tape suffers from rapid wear and tear, leading to frequent replacements. Moreover, grip tape lacks flexibility, which can result in discomfort during prolonged rides. The inability to customize grip tape to suit individual preferences further limits its applicability for advanced riders who demand enhanced performance characteristics.

Metallic spikes, another commonly employed solution, provide a different approach to grip enhancement. They penetrate the soles of the rider's footwear, creating significant friction and thereby increasing stability. However, the use of metallic spikes introduces several issues, including the potential to damage the rider's shoes and create discomfort due to the rigid nature of the spikes. Moreover, metallic spikes can pose a safety hazard, especially in the event of a fall, where they may cause injury.

Rubberized materials, often used in place of or in conjunction with metallic spikes or grip tape, offer an alternative that mitigates some of the discomfort associated with other materials. These rubberized surfaces provide a cushion that can absorb shocks and vibrations, thus enhancing rider comfort. Nonetheless, rubberized materials generally lack the necessary durability and customized grip patterns that advanced riders seek to maximize performance. Furthermore, the environmental impact of the production and disposal of rubberized materials is a growing concern.

Recent advancements in thermoplastics, specifically Polyethylene Terephthalate Glycol (PETG), thermoplastic polyurethane (“TPU”), Polylactic Acid (PLA), present new opportunities for developing gripping surfaces that address these concerns. Thermoplastics like PETG and PLA offer significant benefits, including superior flexibility, durability, and the potential for customized manufacturing through additive manufacturing techniques such as 3D printing. PETG and TPU, in particular, re known for their excellent chemical resistance, impact strength, and ease of 3D printing, which make it an ideal candidate for applications requiring high performance and complex geometries.

Manufacturing technologies, particularly those involving additive manufacturing, have reached a level of maturity that allows for the production of intricate patterns and structures not achievable through traditional manufacturing processes. This technological capability enables the design of gripping surfaces with varied geometric configurations, such as staggered pyramidal structures, that can be fine-tuned to deliver specific performance characteristics. Additionally, 3D printing allows for the integration of aesthetic features, such as color and graphics, directly into the structure of the material, providing both functional and visual enhancements. Another area that grip is needed are surfaces such as steps, boat decks, watercraft decks, and ATVs. These surfaces typically have a rough surface such as grip paper or something similar which can be rough to an individual's skin.

What is needed is an improved gripping surface for personal electric vehicles and boards that addresses the deficiencies of current materials and technologies. Such a solution should offer enhanced durability, the ability to be customized for rider preference, increased comfort during prolonged use, and reduced environmental impact. By leveraging advancements in thermoplastic materials and additive manufacturing techniques, it is possible to fulfill these requirements and provide a gripping surface that meets the evolving demands of personal electric vehicle riders, boards and other gripping surfaces.

### BRIEF SUMMARY OF THE INVENTION

The present invention pertains to a grip device designed to couple to a board's surface for an individual's feet or hands. The grip device can comprise a base layer that attaches to the surface, an adhesive layer on the underside of the base layer for securing the stomp pad to the board, and a traction layer disposed on the base layer. The traction layer includes a plurality of raised pointed protrusions, each having a base profile shape and a height. The protrusions have a substantially similar base profile shape and comprise a plurality of profile sizes and heights.

The grip device can be configured with a variety of raised protrusions, which can be of pyramidal shape. The base layer and traction layer can be rectangular with radius corners on one or both ends or polygonal in shape. The device can be made of a thermoplastic material such as TPU that conforms to the contour of the board's surface. The base profile shape of the protrusions can be a multiple combination of the base profile shape of another one of the protrusions. The grip device can also include at least one cushioning element integrated within the base layer, composed of a material that provides shock absorption to reduce impact forces on the user's foot.

The grip device can be used on various types of boards, including the foot platform of electric unicycles, electric scooters, snowboards, boat deck watercraft decks, all-terrain vehicles, recreational vehicles, fire trucks, emergency vehicles, or skateboards. The thermoplastic material can be heated up to form to a foot pedal, foot pad, or hand pad. The base layer of the grip device can have a thickness of at least 1 mm to at least 5 mm. The raised pointed protrusions can be configured both as isolated units and clustered formations, with the clusters arranged in an irregular pattern, with each subsequent cluster rotated. The cushioning element material can be TPU or TPE. The adhesive layer can be an acrylic adhesive, rubber-based adhesive, or silicone adhesive that is applied to the underside of the base layer. The grip device provides enhanced traction and stability for the user, reducing the risk of slips and falls.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims. Aspects and applications of the invention presented here are described below in the drawings and detailed description of the invention.

It is a further object of the present invention to provide a grip device that includes a plurality of raised protrusions of varying sizes and heights, thereby catering to the different pressure points of a user's foot or hand.

It is a further object of the present invention to provide a grip device made of a thermoplastic material that can conform to the contour of the board's surface, thereby ensuring a secure and stable grip.

It is a further object of the present invention to provide a grip device that includes an adhesive layer for easy and secure attachment to the board.

It is yet a further object of the present invention to provide a grip device that includes a cushioning element integrated within the base layer, thereby providing shock absorption to reduce impact forces on the user's feet or hands.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 shows isometric view of a grip device on an example embodiment in accordance to one or more embodiments;

FIG. 2 shows top view of a grip device in accordance to one or more embodiments;

FIG. 3 shows isometric view of a grip device in accordance to one or more embodiments;

FIG. 4 shows side view of a grip device in accordance to one or more embodiments;

FIG. 5 shows a close-up view of FIG. 2 of a grip device in accordance to one or more embodiments;

FIG. 6 shows isometric view of a grip device in accordance to one or more embodiments;

FIG. 7 shows an isometric view of another embodiment of the grip device in accordance to one or more embodiments;

FIG. 8a shows a top view of another embodiment of the grip device in accordance to one or more embodiments;

FIG. 8b shows a close-up view of another embodiment of the grip device in accordance to one or more embodiments; and

FIG. 9 shows a side view of another embodiment of the grip device in accordance to one or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

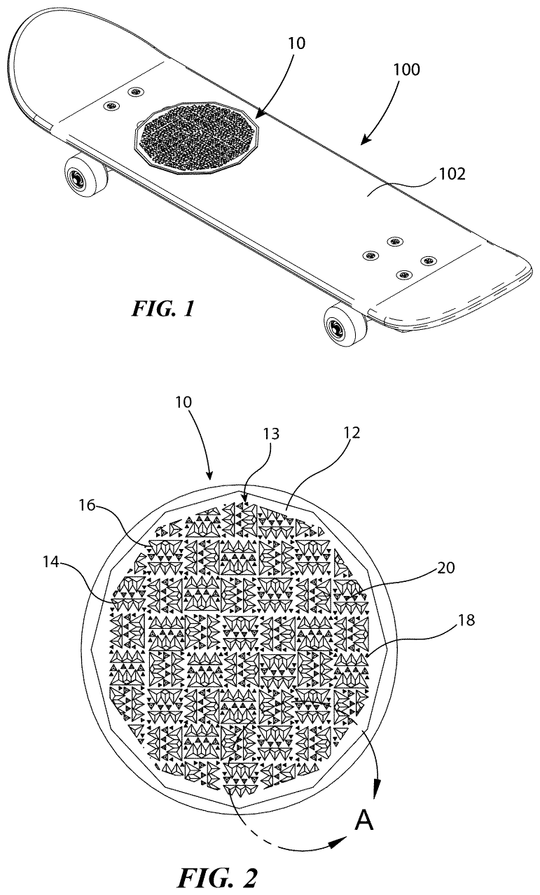

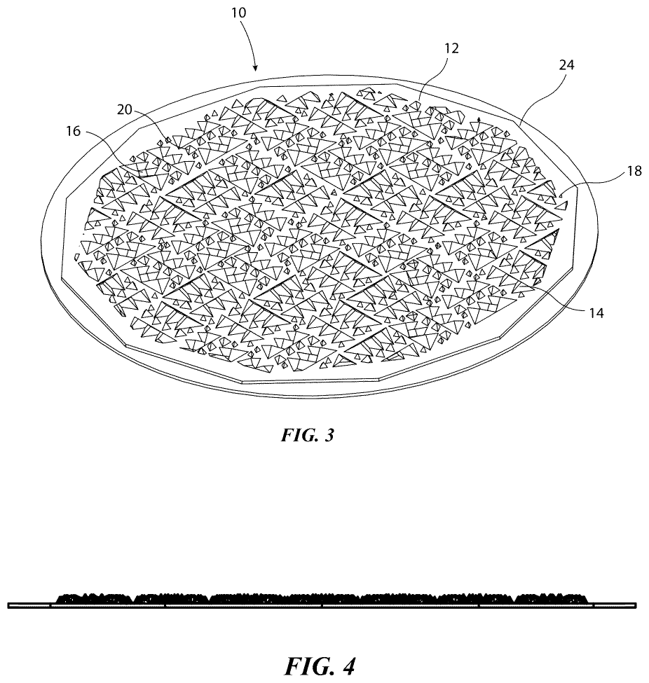

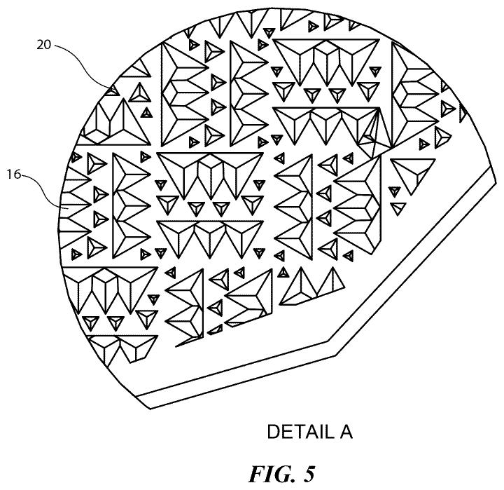

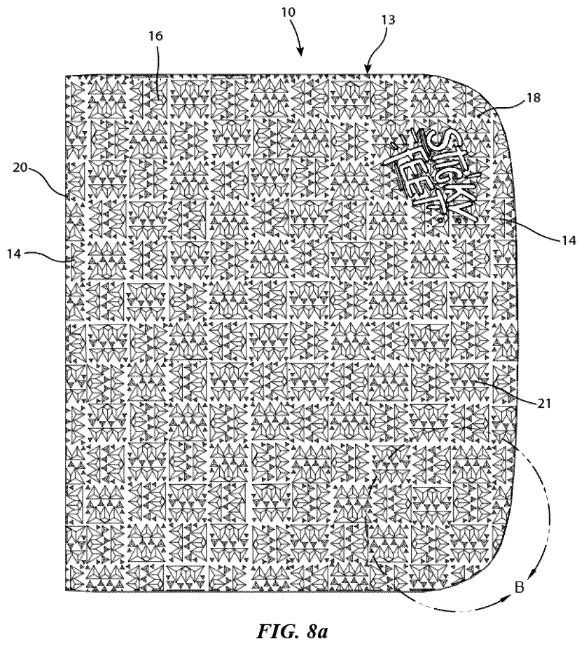

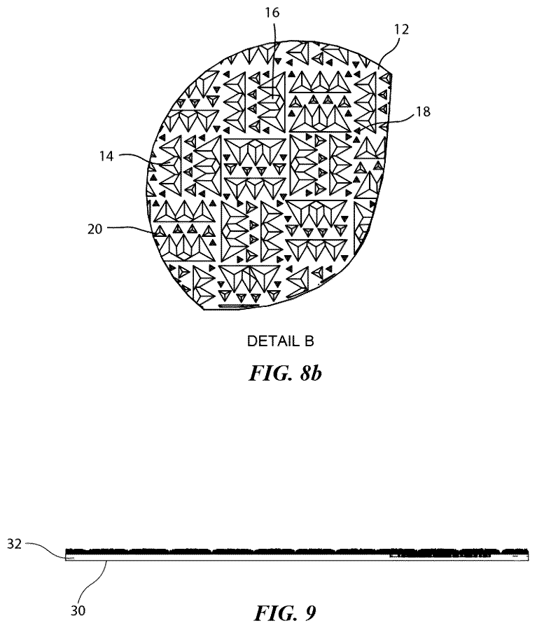

Referring to FIGS. 1-9 a stomp pad device 10 is designed for attachment to a board 100, wherein the board can be such as, for example an electric unicycles (EUCs), electric scooters, snowboard, skateboard, boat decks, watercraft decks, ATVs, recreational vehicles, handles, fire trucks, emergency vehicles, or the like. The device 10 comprises a base layer 12 configured to attach to the surface of the board 102. The base layer 12 can be made of a flexible, durable material that conforms to the contour of the board's surface, providing a secure and stable attachment wherein the flexible material can be such as, for example, PETG, polylactic acid (“PLA”), acrylonitrile butadiene styrene (“ABS”), Nylon, polycarbonate (“PC”), acrylonitrile styrene acrylate (“ASA”), high impact polystyrene (“HIPS”), TPU, thermoplastic elastomer (“TPE”), stainless steel, aluminum, carbon fiber or the like.

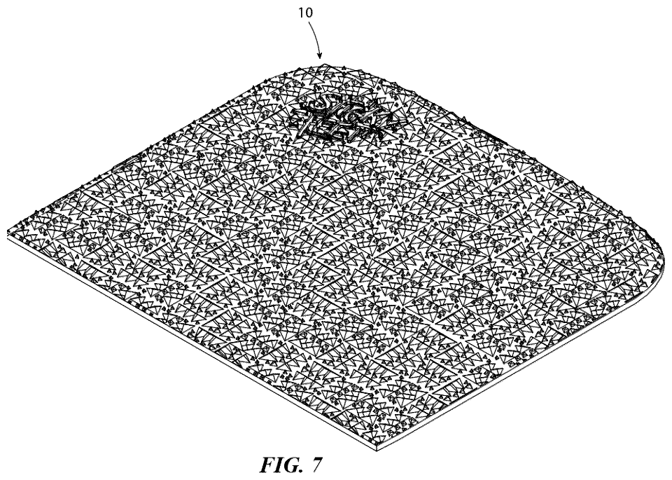

The base layer 12 can be any suitable size, shape and thickness but in the preferred embodiment the base layer is circular, a polygon, or a rectangular shape with radius on one end or both ends as shown in FIG. 7. The base layer 12 can have a thickness 32 of at least 1 mm and in certain embodiments, the base layer 12 thickness can be such as, for example, between 0.5 mm and 15 mm and still more preferably between 0.75 mm and 10 mm and more preferably 1 mm. The base layer 12 can be such as, for example, 157.8 mm in length and 157 mm in width, but can be at least 30 mm to at least 900 mm in length and at least 30 mm to at least 900 mm in width. The base layer's 12 shape can provide an optimal balance of surface area for traction and cushioning, while also allowing for efficient use of materials and manufacturing processes.

The device 10 can have a traction layer 13 disposed on the base layer 12. The traction layer 13 can comprises a plurality of raised pointed protrusions, which can be designed to provide enhanced grip and control for the user foot or hand in certain embodiments wherein each protrusion can have a base profile shape and a height, each base profile shape having a profile size, wherein the plurality of protrusions have a substantially similar base profile shape, and wherein the plurality of protrusions comprises a plurality of profile sizes and a plurality of heights. The raised protrusions can be arranged in a specific pattern, with varying heights and shapes, as detailed in FIGS. 1-9. The raised protrusions can be structures that can strategically printed on the base layer 12, configured both as isolated units and clustered formations wherein the clusters can be arranged in an irregular pattern, with each subsequent cluster rotated such as, for example between 10 degrees to 89 degrees and still more preferable between 20 degrees to 60 degrees and still more preferably 45 degrees. The raised protrusions can allow for various modifications and customizations to suit different preferences and requirements such as, for example, graphic and color, material variability, height variation, base layer dimensions, graphic customization or the like. The plurality of raised protrusions is a first raised protrusion 14, a second raised protrusion 16, a third raised protrusion 18, a fourth raised protrusion 20, and a fifth raised protrusion 21.

The first raised protrusion 14 can be placed at a horizontal and vertical pattern all at the same height, the second raised protrusion 16 can have two protrusions of the same shape and one protrusion between them extending at varying heights, the third raised protrusion 18 is a smaller protrusion than the first protrusion and second protrusion, which can be sporadically located around the traction layer and oriented in varying vertical or horizontal positions. The fourth raised protrusion 20 is larger protrusion than the third raised protrusion that can be sporadically located around the traction layer and oriented in varying vertical or horizontal positions. The fifth raised protrusion 21 can be a larger or smaller protrusion than the third 18 and fourth raised protrusion 20 that can be sporadically located around the traction layer and oriented in varying vertical and/or horizontal positions.

The raised protrusions 13 can vary in shape and size, providing a unique and effective traction pattern on top of the base layer 12. The protrusions can be such as, for example, a pyramid, diamond, square, polygonal, dots, ridges, grids, waves, pyramids, cones, crescents, herringbone or the like. In the preferred embodiment the protrusions can be varying sizes of pyramid shapes either separate or connected together. The first raised protrusion 14, second raised protrusion 16, third raised protrusion 18, and fourth raised protrusion 20 can be varying heights ranging from such as, for example, 1.5 mm to 2.2 mm and the pyramid's base width can be such as, for example, 0.1 mm to 3 mm. In certain embodiments the first raised protrusion 14, second raised protrusion 16, third raised protrusion 18, and fourth raised protrusion 20 can be such as, for example, 0.5 mm to 20 mm and still more preferably 1 mm to 15 mm and still more preferably 1.5 mm to 2.2 mm. The raised protrusions 13 can be made of the same material as the base layer 12 or can be a different material then the base layer such as, for example, polyethylene terephthalate glycol (“PETG”), polylactic acid (“PLA”), acrylonitrile butadiene styrene (“ABS”), Nylon, polycarbonate (“PC”), acrylonitrile styrene acrylate (“ASA”), high impact polystyrene (“HIPS”), stainless steel, aluminum, carbon fiber or the like.

The base layer 12 and the protrusion layer 13 can have graphic and color options which can be, such as, for example, customized with different graphics and colors such as logos and specialty graphics, and the colors can be such as, for example, red, green, blue, violet, purple, black, white, or the like. For implementing graphics, an additional base layer with a thickness of approximately 1 mm and dimensions of 163 mm by 152 mm can be utilized to accommodate the graphic insertion wherein the base layer can incorporate a hole object of about 1.4 mm depth for graphic embedding.

The stomp pad device 10 can be manufactured from such as, for example, injection molding, thermos forming, 3D printing filament such as stereolithography (“SLA”), fused deposition modeling (“FDM”), fused filament fabrication (“FFF”), digital light processing (DLP), selective laser sintering (“SLS”), binder jetting, or the like. 3D printing is the preferred embodiment for making the stomp pad device 10 allowing the manufacture to quickly update features like the shape, size, and graphics. 3D printing allows for material variability allowing one or more materials to printed on top of each other such as PETG can be printed on top of PLA, for example, alternative thermoplastics can be employed for the base layer and the protrusions based on performance requirements or environmental considerations of the user and the item it is attached to. The height of the pyramid structures can be adjusted to achieve specific levels of grip for the rider's comfort. The size and shape of the base layer 12 can be altered to fit different deck dimensions, handle dimension, foot hold dimension or for any custom design needs. Methods for graphic insertion and depth variations can be adjusted to accommodate a wider range of aesthetic choices.

In certain embodiments, the stomp pad device 10 can have at least one cushioning element integrated between or within the base layer 12 and the adhesive layer 30. The cushioning element can be composed of a material that provides shock absorption to reduce impact forces on the user's foot. The cushioning element can be such as, for example, foam, TPU, thermoplastic elastomer (“TPE”), flexible PLA, soft polyurethane, gel resin, or the like. The cushioning element can enhance the comfort and safety of the user during use.

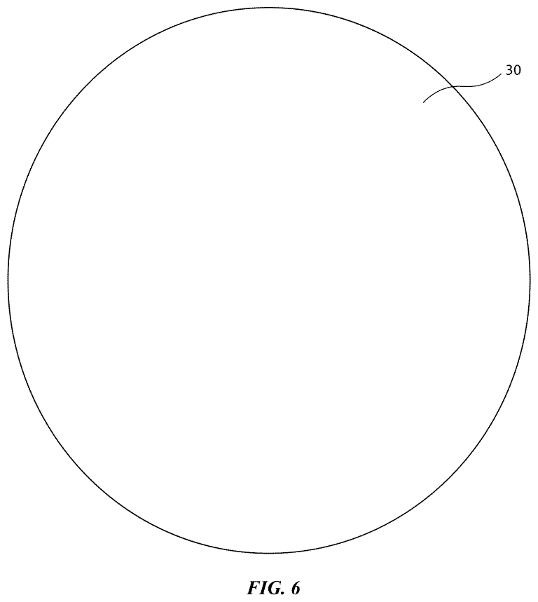

In embodiments, as shown in FIG. 6, on the underside of the base layer 12 is an adhesive layer 60. This adhesive layer 30 can be used for securing the device 10 to the board 100. The adhesive layer 30 can ensures a strong and durable bond between the device 10 and the board 100, allowing for reliable and long-lasting use. The adhesive layer 60 can be such as, for example, acrylic adhesive, rubber-based adhesive, silicone adhesive, water-based adhesive, heat-activate adhesive, pressure sensitive adhesive, or the like. In certain embodiments the adhesive layer 60 can be omitted and the stomp pad device 10 can be fastened by such as, for example, bolts, screws, rivets, hook and loop fasteners, or the like.

The stomp pad device 10 can provide a significant improvement over prior art, offering enhanced traction, comfort, and durability for personal electric vehicle and board sports enthusiasts. The unique design and arrangement of the raised protrusions, along with the integrated cushioning element and adhesive layer can provide a comprehensive solution for improving board control and user safety. While the stomp pad device 10 has been particularly shown and described with reference to a preferred embodiment thereof, it will be understood by those skilled in the art that changes in form and detail may be made therein without departing from the spirit and scope of the invention.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

We claim:

1. A grip device configured to couple to a board having a surface for an individual's feet or hands comprising:
a base layer configured to attach to the surface;
an adhesive layer on the underside of the base layer for securing the stomp pad to the board; and
a traction layer disposed on the base layer, the traction layer comprising a plurality of raised pointed protrusions, each protrusion having a base profile shape and a height, each base profile shape having a profile size, wherein the plurality of protrusions has a substantially similar base profile shape, and wherein the plurality of protrusions comprises a plurality of profile sizes and a plurality of heights.

2. The grip device of claim 1 wherein the plurality of raised protrusions are a first raised protrusion, a second raised protrusion, a third raised protrusion, a fourth raised protrusion, and a fifth raised protrusion.

3. The grip device of claim 2 wherein the plurality of raised protrusions is a pyramidal shape.

4. The grip device of claim 1 wherein the base layer and traction layer is a rectangular shape with radius corners on one end or both ends or is polygonal in shape.

5. The grip device of claim 1 wherein the base layer and traction layer is made of a thermoplastic material such as TPU that conforms to the contour of the board's surface.

6. The grip device of claim 1 wherein the at least one of the plurality of protrusions has a base profile shape that is a multiple combination of the base profile shape of another one of the plurality of protrusion.

7. The grip device of claim 1 wherein at least one cushioning element integrated within the base layer, the cushioning element being composed of a material that provides shock absorption to reduce impact forces on the user's foot.

8. The grip device of claim 5 wherein the board is the foot platform of an electric unicycles (EUCs), electric scooters, snowboard, boat deck watercraft decks, all-terrain vehicles, recreational vehicle, fire trucks, emergency vehicles or skateboards.

9. The grip device of claim 4 wherein the thermoplastic material is heated up to form to a foot pedal, foot pad, or hand pad.

10. The grip device of claim 1 wherein the base layer has a thickness of at least 1 mm to at least 5 mm.

11. The grip device of claim 2 wherein the plurality of raised pointed protrusions is configured both as isolated units and clustered formations wherein the clusters are arranged in an irregular pattern, with each subsequent cluster rotated.

12. The grip device of claim 7 wherein the at least one cushioning element material is TPU or TPE.

13. The grip device of claim 11 wherein the first raised protrusion is placed at a horizontal and vertical pattern all at the same height, the second raised protrusion is two protrusions of the same shape and one protrusion between them extending at varying heights, the third raised protrusion is a smaller protrusion than the first protrusion and second protrusion, which is sporadically located around the traction layer and oriented in varying vertical or horizontal positions, the fourth raised protrusion is larger protrusion than the third raised protrusion which is sporadically located around the traction layer and oriented in varying vertical or horizontal positions, and the fifth raised protrusion is larger or smaller protrusion than the third and fourth raised protrusion.

14. The grip device of claim 1 wherein the adhesive layer is an acrylic adhesive, rubber-based adhesive, or silicone adhesive that is applied to the underside of the base layer.
